(19) United States
(12) Patent Application Publication
(10) Pub. No.: US 2003/0068258 A1
(43) Pub. Date: Apr. 10, 2003

(54) Apparatus for producing aluminum nitride

(75) Inventors: Shyan-Lung Chung, Yung-Kang City (TW); Chun-Nan Lin, Chang-Hua City (TW); Jeng-Chiuan Chen, Keelung City (TW); Shui-Chin Liu, Taipei City (TW)

Correspondence Address: SUGHRUE MION, PLLC, 2100 Pennsylvania Avenue, NW, Washington, DC, 20037-3213, US

(73) Assignee: NATIONAL CHENG KUNG UNIVERSITY

(21) Appl. No.: 10/242,459

(22) Filed: Sep. 13, 2002

(30) Foreign Application Priority Data
Oct. 4, 2001 (TW) 090216910

(51) Int. Cl. F28D 21/00; G05D 23/00; G05D 16/00

(52) U.S. Cl. 422/187; 422/198; 422/202; 422/109; 422/112; 422/199

(57) ABSTRACT

A reactor includes a cylindrical chamber having an opening transverse to an axial direction of the cylindrical chamber, a cover movable along the axial direction between an open state in which the cover is away from the opening of the cylindrical chamber, and a closed state in which the cover seals the opening of the cylindrical chamber, and an actuator unit connected to said cover. An apparatus for producing aluminum nitride including the reactor is also disclosed.

### CROSS-REFERENCE TO RELATED APPLICATION

This application claims priority of Taiwanese application No. 090216910, filed on Oct. 4, 2001.

### BACKGROUND OF THE INVENTION

1. Field of the Invention

The present invention relates to an apparatus for producing aluminum nitride, more particularly to an apparatus for producing aluminum nitride by combustion synthesis method.

2. Description of the Related Art

Aluminum nitride is a material superior in properties, such as heat conductivity, electrical insulation, thermal expansion, heat shock resistance, and corrosion resistance. Therefore, aluminum nitride is broadly used in various fields, such as electronic substrates, packing materials for integrated circuits, heat dissipators for electronic devices, heat conductive pastes, high heat conductive composite materials, and containers for receiving and processing molten salts or metals.

Conventional methods for manufacturing aluminum nitride powder include the gas phase reaction method, the organometal precursor method, the reduction-nitridation method, the direct nitridation method, and the combustion synthesis method.

The combustion synthesis method is a method for synthetizing ceramic materials by self-propagation combustion reaction. The details thereof are disclosed in Combust. Sci. Technol. 10, 195 (1975). The reactor used for synthetizing aluminum nitride powder by combustion synthesis is well known. U.S. Pat. Nos. 5,460,794 and 5,453,707 use a rectangular pressure-resistant reactor made of stainless steel for the synthesis of aluminum nitride powder. The disadvantages thereof are the uneven pressure in the reactor, which can result in destruction of the reactor, and the frequent opening and sealing of the cover, which makes the reactor unsuitable for continuous operation. U.S. Pat. No. 5,693,305 discloses two types of reactors used for the synthesis of aluminum nitride whiskers. One is a box furnace for batch-type synthesis of aluminum nitride whiskers, and the other is a continuous synthesis reactor for the continuous synthesis of aluminum nitride whiskers. In addition to the aforesaid disadvantages, both the box furnace and the continuous synthesis reactor are energy consuming because of the requirement of long heating period at high temperature (1000-1500° C.). Furthermore, the continuous supply of nitrogen into the reactor for providing a nitrogen atmosphere in the reactor is costly.

### SUMMARY OF THE INVENTION

Therefore, the object of the present invention is to provide an improved apparatus for producing aluminum nitride by combustion synthesis so as to overcome the aforesaid disadvantages.

In one aspect, a reactor according to this invention includes a cylindrical chamber, a cover and an actuator unit. The cylindrical chamber has an opening transverse to an axial direction of the cylindrical chamber. The cover is movable along the axial direction between an open state in which the cover is away from the opening of the cylindrical chamber, and a closed state in which the cover seals the opening of the cylindrical chamber. The actuator unit is connected to the cover.

In another aspect, an apparatus for producing aluminum nitride according to this invention includes a reactor, a cover, an actuator, a vacuum device, a nitrogen supplying device, a heating device, and a control unit. The reactor includes a cylindrical chamber, a cooling jacket for cooling the reactor, and an opening transverse to an axial direction of the cylindrical chamber. The opening is adapted to permit a reactant to enter into the chamber. The cover is movable between an open state in which the cover is away from the opening, and a closed state in which the cover seals the opening. The cover has an inner side which carries an integral reactant platform and an outer side which is jacketed. The actuator is connected to the outer side of the cover to move the cover between the open and closed states. The vacuum device is connected to the reactor to vacuum the chamber. The nitrogen supplying device supplies nitrogen into the chamber. The heating device is disposed inside the chamber for igniting the reactant in the presence of nitrogen. The control unit controls temperature and pressure within the chamber.

### BRIEF DESCRIPTION OF THE DRAWING

Other features and advantages of the present invention will become apparent in the following detailed description of the preferred embodiments with reference to the accompanying drawing, of which:

FIGS. 1 and 2 illustrate a first preferred embodiment of the apparatus for producing aluminum nitride according to this invention; and

FIGS. 3 and 4 illustrate a second preferred embodiment of the apparatus for producing aluminum nitride according to this invention.

### DETAILED DESCRIPTION OF THIS INVENTION

Before the present invention is described in greater detail, it should be noted that like elements are denoted by the same reference numerals throughout the disclosure.

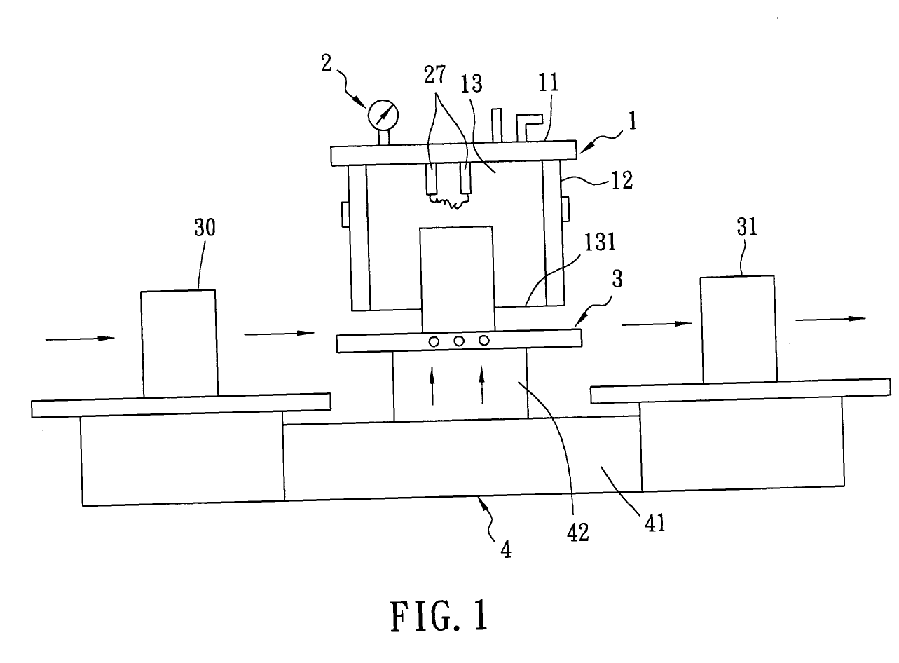

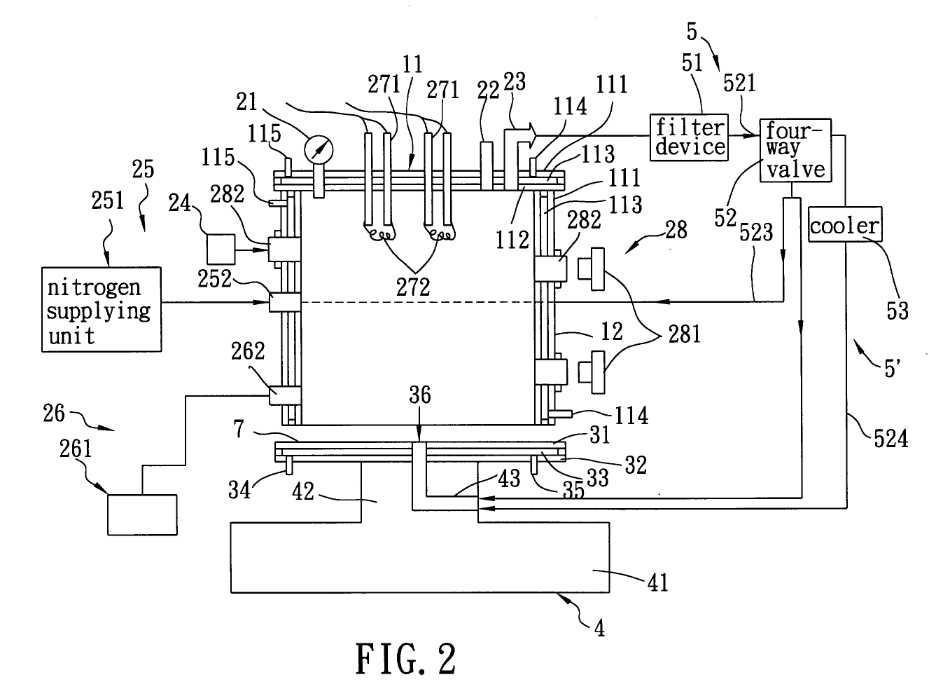

Referring to FIGS. 1 and 2, the first preferred embodiment of the apparatus for producing aluminum nitride according to this invention is shown to include a reactor 1, a cover 3, an actuator 4, a vacuum device 26, a nitrogen supplying device 25, a heating device 27, a control unit 2, a nitrogen recovering unit 5, and a nitrogen recycling unit 5′.

The reactor 1 is in a vertical form and includes a cylindrical chamber 13, a cooling jacket 113 for cooling the reactor 1, and an opening 131 transverse to an axial direction of the cylindrical chamber 13. The cylindrical chamber 13 is defined by a chamber wall including a top wall 11 and a side wall 12 extending downwardly from the periphery of the top wall 11. The top wall 11 and the side wall 12 respectively include an outer wall 111 made of stainless steel and an inner wall 112 made of stainless steel. The outer and inner walls 111, 112 are spaced apart from each other by the cooling jacket 113. The top wall 11 and the side wall 12 are respectively provided with a cooling medium inlet port 114 and a cooling medium outlet port 115, which fluidly communicate with the cooling jacket 113. The cooling medium enters into the cooling jacket 113 via the inlet port 114 and exits out of the cooling jacket 113 via the outlet port 115 so as to remove the heat that results from the reaction within the reactor 1 to avoid deformation of the reactor 1. The opening 131 is adapted to permit a reactant 30 to enter into the chamber 13.

The cover 3 is movable linearly between an open state in which the cover 3 is away from the opening 131, and a closed state in which the cover 3 seals the opening 131 along the axial direction of the cylindrical chamber 13. The cover 3 has an inner side 31 which is made of stainless steel and which carries an integral reactant platform 7, and an outer side 32 which is made of stainless steel and which is jacketed (i.e., a cooling jacket 33 is formed between the inner side 31 and the outer side 32). The cover 3 is also provided with a cooling medium inlet port 34 and a cooling medium outlet port 35, which fluidly communicate with the cooling jacket 33 of the cover 3. The cooling medium enters into the cooling jacket 33 of the cover 3 via the inlet port 34 of the cover 3 and exits out of the cooling jacket 33 of the cover 3 via the outlet port 35 of the cover 3 so as to remove the heat that results from the reaction within the reactor 1.

The actuator 4 is hydraulically operated and is connected to the outer side 32 of the cover 3 to move the cover 3 between the open and closed states. The actuator 4 includes a base 41, an actuating bar 42 for actuating the cover 3 to move vertically between the open state and the closed state, and a channel 43.

The vacuum device 26 is connected to the reactor 1 to vacuum the chamber 13 before the reaction. The vacuum device 26 includes a vacuum port 262 provided on the side wall 12, and a vacuum pump 261 for vacuuming the cylindrical chamber 13 of the reactor 1 via the vacuum port 262.

The nitrogen supplying device 25 includes a nitrogen inlet port 252 and a nitrogen supplying unit 251 supplying nitrogen of high purity (about 99.99%) into the chamber 13.

The heating device 27 is disposed inside the chamber 13 for igniting the reactant 30 in the presence of nitrogen. The heating device 27 includes a plurality of heating electrodes 271 and heating elements 272 connected to the heating electrodes 271. The heating elements 272 are selected from tungsten filament, tungsten sheet, graphite, silicon carbide, molybdenum silicide, chromel filament, tantalum filament, and the like. Alternatively, the heating elements 272 may be heated via electricity, laser, infrared radiation or microwave to a temperature sufficient for initiating the reaction.

The control unit 2 controls the temperature and pressure within the chamber 13. The control unit 2 includes a pressure detector 21 for detecting pressure within the chamber 13 of the reactor 1, a safety valve 22 for maintaining the pressure in the chamber 13 of the reactor 1 within a safety range, and a temperature recorder 24 (for example, an infrared radiation thermometer) for recording temperature within the chamber 13 of the reactor 1. The pressure detector 21 and the safety valve 22 are provided on the top wall 11 of the chamber 13. The temperature recorder 24 is provided on the side wall 12 of the chamber 13. Additionally, the control unit 2 has a monitoring system 28 for monitoring changes in the combustion reaction within the reactor 1. The monitoring system 28 includes a plurality of monitors 281 and a plurality of quartz windows 282 provided on the side wall 12 of the chamber 13.

The nitrogen recovering unit 5 includes a nitrogen outlet port 23 provided on the top wall 11 of the chamber 13 at a location away from the opening 131, a filter device 51 connected to the nitrogen outlet port 23 for filtering nitrogen exiting from the nitrogen outlet port 23, a first recycling passage 521 connected to the filter device 51, and a four-way valve 52 connected to the filter device 51 and the nitrogen inlet port 252 via the first recycling passage 521 and a third recycling passage 523, respectively, so as to return the nitrogen to the chamber 13 from the filter device 51. The nitrogen recovering unit 5 further includes a cooler 53 connected to the filter device 51 via the four-way valve 52 to cool the nitrogen from the filter device 51, a second recycling passage 524 connected to the cooler 53, and a recycling port 36 disposed in the cover 3 and connected to the second recycling passage 524 via the channel 43 of the actuator 4 to permit the nitrogen from the cooler 53 to flow over the reactant platform 7 so as to cool the product 31 formed from the reactant 30. Alternatively, the nitrogen from the four-way valve 52 can flow directly to the recycling port 36 without passing through the cooler 53.

In addition, the nitrogen outlet port 23, the filter device 51, the cooler 53, the second recycling passage 524, and the recycling port 36 cooperate to form a nitrogen recycling unit 5′.

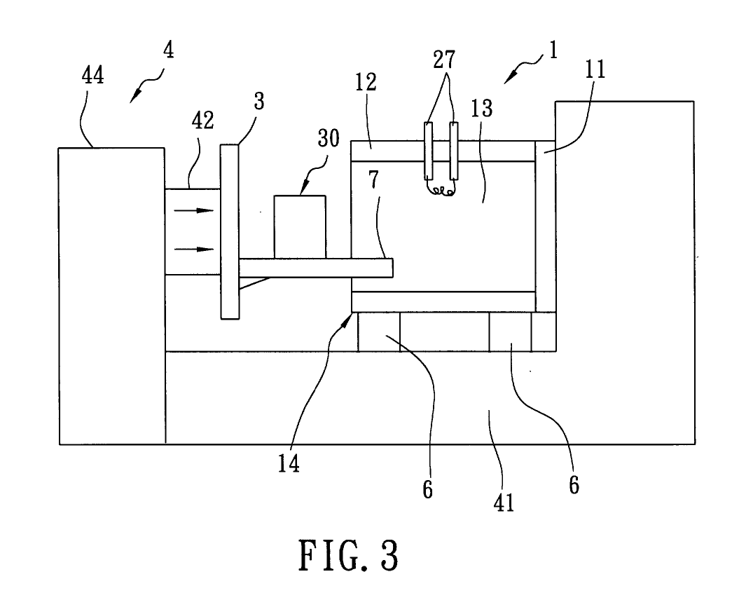

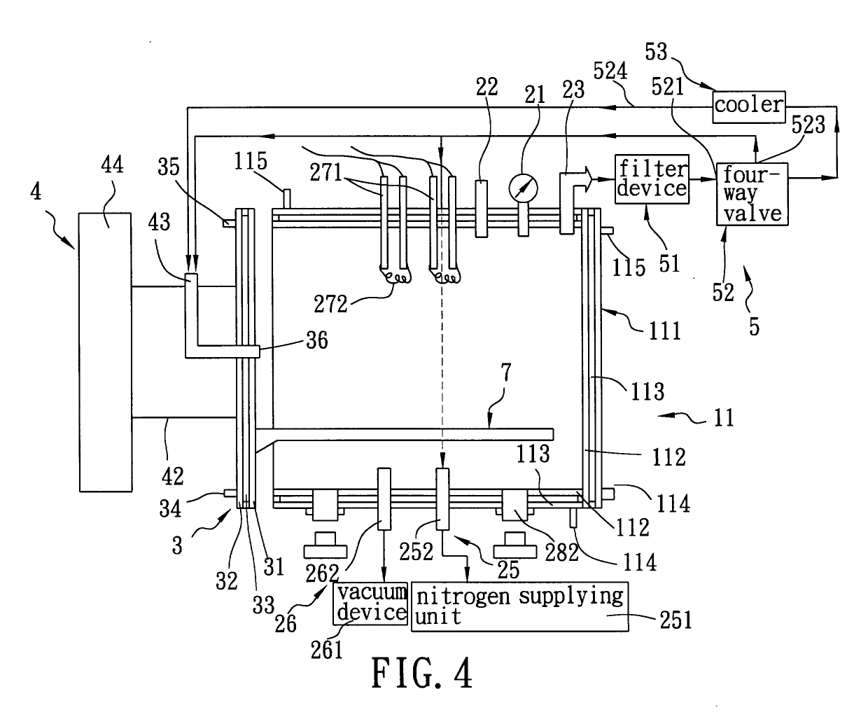

Referring to FIGS. 3 and 4, which shows the second preferred embodiment of the apparatus for producing aluminum nitride according to this invention, the apparatus shown in FIGS. 3 and 4 is similar to that shown in FIGS. 1 and 2 except that the reactor in FIGS. 3 and 4 is in a horizontal form. Two fixing supports 6 are provided on the base 41 of the actuator 4 for supporting the reactor 1. The cover 3 is actuated by the actuating bar 42 of the actuator 4 to move horizontally between the open state and the closed state. The inner side 31 of the cover 3 is disposed vertically. The reactant platform 7 is disposed horizontally and is attached integrally to the inner side 31 of the cover 3.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

John H. Mion Reg. No. 18,879

Donald E. Zinn Reg. No. 19,046

Thomas J. Macpeak Reg. No. 19,292

Robert J. Seas, Jr. Reg. No. 21,092

Darryl Mexic Reg. No. 23,063

Robert V. Sloan Reg. No. 22,775

Peter D. Olexy Reg. No. 24,513

J. Frank Osha Reg. No. 24,625

Waddell A. Biggart Reg. No. 24,861

Robert G. McMorrow Reg. No. 19,093

Louis Gubinsky Reg. No. 24,835

Neil B. Siegel Reg. No. 25,200

David J. Cushing Reg. No. 28,703

John R. Inge Reg. No. 26,916

Joseph J. Ruch, Jr. Reg. No. 26,577

Sheldon I. Landsman Reg. No. 25,430

Richard C. Turner Reg. No. 29,710

Howard L. Bernstein Reg. No. 25,665

Alan J. Kasper Reg. No. 25,426

Kenneth J. Burchfiel Reg. No. 31,333

Gordon Kit Reg. No. 30,764

Susan J. Mack Reg. No. 30,951

Frank L. Bernstein Reg. No. 31,484

Mark Boland Reg. No. 32,197

William H. Mandir Reg. No. 32,156

Scott M. Daniels Reg. No. 32,562

Brian W. Hannon Reg. No. 32,778

We claim:

1. A reactor comprising:
a cylindrical chamber having an opening transverse to an axial direction of said cylindrical chamber;
a cover movable along said axial direction between an open state in which said cover is away from said opening of said cylindrical chamber, and a closed state in which said cover seals said opening of said cylindrical chamber; and
an actuator unit connected to said cover.

2. The reactor as claimed in claim 1, wherein said cover carries a reactant platform which extends into said cylindrical chamber when said cover is in said closed state.

3. The reactor as claimed in claim 1, wherein said cylindrical chamber includes a cylindrical side wall and an end wall mounted on said cylindrical wall opposite to said opening, at least one of said cylindrical side wall and said end wall including a cooling jacket for cooling said reactor.

4. The reactor as claimed in claim 1, wherein said cover is jacketed.

5. An apparatus for producing aluminum nitride, comprising:
a reactor including a chamber, a cooling jacket for cooling said reactor, and an opening transverse to an axial direction of said chamber, said opening being adapted to permit a reactant to enter into said chamber;
a cover movable between an open state in which said cover is away from said opening, and a closed state in which said cover seals said opening, said cover having an inner side which carries an integral reactant platform and an outer side which is jacketed;
an actuator connected to said outer side of said cover to move said cover between said open and closed states;
a vacuum device connected to said reactor to vacuum said chamber;
a nitrogen supplying device for supplying nitrogen into said chamber;
a heating device disposed inside said chamber for igniting the reactant in the presence of nitrogen; and
a control unit to control temperature and pressure within said chamber.

6. The apparatus as claimed in claim 5, wherein said chamber has a chamber wall, said nitrogen supplying device having a nitrogen inlet port disposed on said chamber wall.

7. The apparatus as claimed in claim 5, wherein said actuator is a hydraulically operated actuator.

8. The apparatus as claimed in claim 6, further comprising a nitrogen recovering unit which includes a nitrogen outlet port provided on said chamber wall at a location away from said opening, a filter device connected to said nitrogen outlet port for filtering nitrogen exiting from said nitrogen outlet port, a first recycling passage connected to said filter device, and a third recycling passage connected between said first recycling passage and said nitrogen inlet port of said nitrogen supplying device to return the nitrogen to said chamber from said filter device.

9. The apparatus as claimed in claim 8, wherein said nitrogen recovering unit further includes a cooler connected to said filter device to cool the nitrogen from said filter device, a second recycling passage connected to said cooler, and a recycling port disposed in said cover and connected to said second recycling passage to permit the nitrogen from said cooler to flow over said reactant platform so as to cool the product formed from the reactant.

10. The apparatus as claimed in claim 6, further comprising a nitrogen recycling unit which includes a nitrogen outlet port provided on said chamber wall at a location away from said opening, a filter device connected to said nitrogen outlet port for filtering nitrogen exiting from said nitrogen outlet port, a cooler connected to said filter device to cool the nitrogen from said filter device, a recycling passage connected to said cooler, and a recycling port disposed in said cover and connected to said recycling passage to permit the nitrogen from said cooler to flow over said reactant platform so as to cool the product formed from the reactant.

11. The apparatus as claimed in claim 5, wherein said chamber is cylindrical.

12. The apparatus as claimed claim 5, wherein said cover is movable linearly between said open and closed states along an axial direction of said chamber.

13. The apparatus as claimed in claim 12, wherein said cover moves horizontally, said inner side of said cover being disposed vertically, said reactant platform being disposed horizontally and being attached integrally to said inner side of said cover.

14. The apparatus as claimed in claim 5, wherein said heating device includes a plurality of heating electrodes and heating elements connected to said electrodes.

15. The apparatus as claimed in claim 5, wherein said control unit includes a pressure detector for detecting pressure within said chamber.

16. The apparatus as claimed in claim 5, wherein said control unit includes a safety valve for maintaining the pressure in said chamber within a safety range.

17. The apparatus as claimed in claim 5, wherein said control unit includes a temperature recorder for recording temperature within said chamber.
